(19) United States
(12) Patent Application Publication
(10) Pub. No.: US 2024/0345209 A1
(43) Pub. Date: Oct. 17, 2024

(54) WIRELESS COMMUNICATION AND SENSING METHOD AND DEVICE THEREOF

(71) Applicant: ZTE CORPORATION, Shenzhen (CN)

(72) Inventors: Yihua MA, Shenzhen (CN); Zhifeng YUAN, Shenzhen (CN); Shuqiang XIA, Shenzhen (CN); Guanghui YU, Shenzhen (CN); Liujun HU, Shenzhen (CN)

(73) Assignee: ZTE CORPORATION, Shenzhen (CN)

(21) Appl. No.: 18/661,846

(22) Filed: May 13, 2024

Related U.S. Application Data
(63) Continuation of application No. PCT/CN2022/084816, filed on Apr. 1, 2022.

(51) Int. Cl. G01S 7/00; G01S 7/02; G01S 13/00; G01S 13/34; G01S 13/87

(52) U.S. Cl. CPC G01S 7/006; G01S 7/0232; G01S 7/0235; G01S 13/003; G01S 13/343; G01S 13/878

(57) ABSTRACT

A wireless communication and sensing method for use in a wireless communication and sensing node is disclosed. The method comprises transmitting an integrated sensing and communication, ISAC, signal, wherein a sensing signal in the ISAC signal comprises a wideband signal and at least one single-tone signal, wherein the number of the at least one single-tone signal is less than 10, and wherein a bandwidth of the wideband signal is greater than 1 MHz.

### CROSS-REFERENCE TO RELATED APPLICATION

This is a continuation of PCT Patent Application No. PCT/CN2022/084816, filed on Apr. 1, 2022, the disclosure of which is incorporated herein by reference in its entirety.

### TECHNICAL FIELD

This document is directed generally to wireless communications, and in particular to 6^{th} generation (6G) communications.

### BACKGROUND

Integrated sensing and communication (ISAC) is expected to provide enormous add-on values to the communication systems in the 6G era.

### SUMMARY

The sensing signal in existing ISAC schemes can be Orthogonal Frequency-division Multiplexing (OFDM) or Frequency Modulated Continuous Wave (FMCW) signal.

When the OFDM signal is used for sensing, it is possible to reuse the communications signal to avoid sensing overheads. However, it requires complex full-duplex hardware to cancel self-interference, and the sensing beam can be different from the communications beam.

When the FMCW signal is used for sensing, the self-interference cancellation hardware can be simple. However, FMCW requires a lot of time-frequency resources to ensure the performance.

Thus, one major challenge for the ISAC is how to allocate the limited spectrum resources to ensure the performance of both communication and sensing functions.

In order to overcome the above problems, the present disclosure proposes a novel sensing signal forming a large radar aperture with only a small portion of spectrum resources.

One aspect of the present disclosure relates to a wireless communication and sensing method for use in a wireless communication and sensing node. The method comprises:
transmitting an integrated sensing and communication, ISAC, signal,
wherein a sensing signal in the ISAC signal comprises a wideband signal and at least one single-tone signal,
wherein the number of the at least one single-tone signal is less than 10, and
wherein a bandwidth of the wideband signal is greater than 1 MHz.

Another aspect of the present disclosure relates to a wireless communication and sensing method for use in a wireless communication and sensing node, the method comprising:
receiving an integrated sensing and communication, ISAC, signal, and
determining communication information and sensing information based on the ISAC signal,
wherein a sensing signal in the ISAC signal comprises a wideband signal and at least one single-tone signal,
wherein the number of the at least one single-tone signal is less than 10, and
wherein a bandwidth of the wideband signal is greater than 1 MHz.

Various embodiments may preferably implement the following features:

Preferably or in some embodiments, the number of the at least one single-tone signal is 1.

Preferably or in some embodiments, the wideband signal is one of a Frequency-Modulated Continuous Wave, FMCW, signal, a pulse signal or a low-correlation sequence signal.

Preferably or in some embodiments, the bandwidth of the wideband signal covers all sub-carriers of the ISAC signal.

Preferably or in some embodiments, the bandwidth of the wideband signal covers more than 90% of sub-carriers of the ISAC signal.

Preferably or in some embodiments, a time duration of the wideband signal is less than 10% of a time duration of the ISAC signal.

Preferably or in some embodiments, a time spacing between the first time-domain position and the last time-domain position of the single-tone signal is greater than 90% of a time duration of the ISAC signal.

Preferably or in some embodiments, a duty cycle of the single-tone signal is within 0% to 100%.

Preferably or in some embodiments, time-domain positions of the single-tone signal are periodic or non-periodic.

Preferably or in some embodiments, a phase of the single-tone signal is continuous or discontinuous.

Preferably or in some embodiments, the ISAC signal further comprises at least one guard band between the single-tone signal and a communication signal of the ISAC signal.

Preferably or in some embodiments, the single-tone signal is on a subcarrier with the highest frequency or the lowest frequency in the ISAC signal.

Preferably or in some embodiments, each guard band covers at least one subcarrier of the ISAC signal.

Preferably or in some embodiments, the at least one single-tone signal is a reference signal of a communication signal in the ISAC signal.

Preferably or in some embodiments, transmitting/receiving the ISAC signal comprises transmitting/receiving at least one signal component of the sensing signal via a plurality of antennas and/or a plurality of beams.

Preferably or in some embodiments, at least one signal component of the sensing signal corresponds to a plurality of antennas and/or a plurality of beams.

Preferably or in some embodiments, receiving the ISAC signal comprises receiving an echo signal corresponding to the sensing signal of the ISAC signal.

Preferably or in some embodiments, the ISAC signal is transmitted and received by the same wireless communication and sensing node.

Preferably or in some embodiments, the ISAC signal is transmitted by one wireless communication and sensing node and received by another wireless communication and sensing node.

In an embodiment, a total time duration of the wideband signal is less than a total time duration of the at least one single-tone signal.

Still another aspect of the present disclosure relates to a wireless communication and sensing node. The wireless communication and sensing node comprises:
a communication unit, configured to transmit an integrated sensing and communication, ISAC, signal,
wherein a sensing signal in the ISAC signal comprises a wideband signal and at least one single-tone signal, wherein the number of the at least one single-tone signal is less than 10, and
wherein a bandwidth of the wideband signal is greater than 1 MHz.

Various embodiments may preferably implement the following feature:

Preferably or in some embodiments, the wireless communication and sensing node further comprises a processor configured to perform any of aforementioned wireless communication and sensing methods.

Yet another aspect of the present disclosure relates to a wireless communication and sensing node. The wireless communication and sensing node comprises:
a communication unit, configured to transmit an integrated sensing and communication, ISAC, signal, and
a processor, configured to determine communication information and sensing information based on the ISAC signal,
wherein a sensing signal in the ISAC signal comprises a wideband signal and at least one single-tone signal,
wherein the number of the at least one single-tone signal is less than 10, and
wherein a bandwidth of the wideband signal is greater than 1 MHz.

Preferably or in some embodiments, the processor is further configured to perform any of aforementioned wireless communication and sensing methods.

The present disclosure also relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a wireless terminal according to an embodiment of the present disclosure.

FIG. 2 shows a schematic diagram of a wireless network node according to an embodiment of the present disclosure.

FIG. 3 shows an ISAC signal in the time-frequency domain according to an embodiment of the present disclosure.

FIG. 4 shows another ISAC signal in the time-frequency domain according to an embodiment of the present disclosure.

FIG. 5 shows another ISAC signal in the time-frequency domain according to an embodiment of the present disclosure.

FIG. 6 shows another ISAC signal in the time-frequency domain according to an embodiment of the present disclosure.

FIG. 7 shows another ISAC signal in the time-frequency domain according to an embodiment of the present disclosure.

FIG. 8 shows another ISAC signal in the time-frequency domain according to an embodiment of the present disclosure.

FIG. 9 shows another ISAC signal in the time-frequency domain according to an embodiment of the present disclosure.

FIG. 10 shows another ISAC signal in the time-frequency domain according to an embodiment of the present disclosure.

FIG. 11 shows another ISAC signal in the time-frequency domain according to an embodiment of the present disclosure.

FIG. 12 shows the real part of sensing signal in an ISAC signal in the time domain according to an embodiment of the present disclosure.

FIG. 13 shows the real part of sensing signal in another ISAC signal in the time domain according to an embodiment of the present disclosure.

FIG. 14 shows the real part of sensing signal in another ISAC signal in the time domain according to an embodiment of the present disclosure.

FIG. 15 shows the sensing part in an ISAC signal in the time-frequency-spatial domain according to an embodiment of the present disclosure.

FIG. 16 shows the monostatic sensing mode according to an embodiment of the present disclosure.

FIG. 17 shows the bistatic and multi-static sensing mode according to an embodiment of the present disclosure.

FIG. 18 shows the monostatic plus bistatic sensing mode according to an embodiment of the present disclosure.

FIG. 19 shows the multi-cell monostatic sensing according to an embodiment of the present disclosure.

FIGS. 20 and 21 shows flowcharts of methods according to some embodiments of the present disclosure.

### DETAILED DESCRIPTION

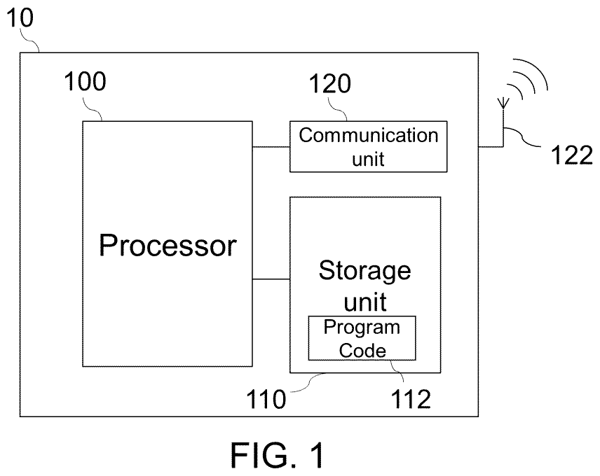

FIG. 1 relates to a schematic diagram of a wireless terminal 10 according to an embodiment of the present disclosure. The wireless terminal 10 may be a user equipment (UE), a mobile phone, a laptop, a tablet computer, an electronic book or a portable computer system and is not limited herein. The wireless terminal 10 may include a processor 100 such as a microprocessor or Application Specific Integrated Circuit (ASIC), a storage unit 110 and a communication unit 120. The storage unit 110 may be any data storage device that stores a program code 112, which is accessed and executed by the processor 100. Embodiments of the storage unit 112 include but are not limited to a subscriber identity module (SIM), read-only memory (ROM), flash memory, random-access memory (RAM), hard-disk, and optical data storage device. The communication unit 120 may a transceiver and is used to transmit and receive signals (e.g., messages or packets) according to processing results of the processor 100. In an embodiment, the communication unit 120 transmits and receives the signals via at least one antenna 122 shown in FIG. 1.

In an embodiment, the storage unit 110 and the program code 112 may be omitted and the processor 100 may include a storage unit with stored program code.

The processor 100 may implement any one of the steps in exemplified embodiments on the wireless terminal 10, e.g., by executing the program code 112.

The communication unit 120 may be a transceiver. The communication unit 120 may as an alternative or in addition be combining a transmitting unit and a receiving unit configured to transmit and to receive, respectively, signals to and from a wireless network node (e.g., a base station).

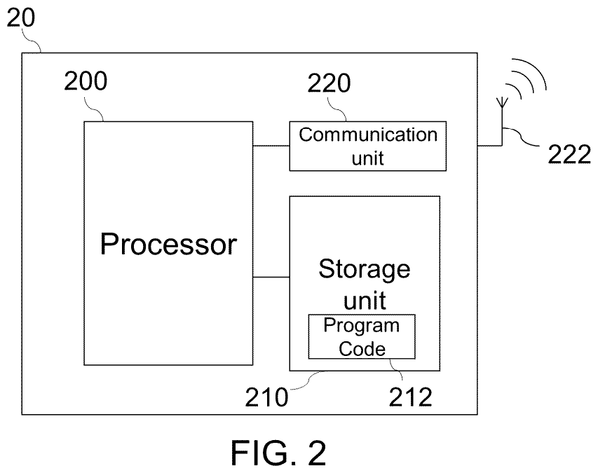

FIG. 2 relates to a schematic diagram of a wireless network node 20 according to an embodiment of the present disclosure. The wireless network node 20 may be a satellite, a base station (BS), a smart node, a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 20 may comprise (perform) at least one network function such as an access and mobility management function (AMF), a session management function (SMF), a user place function (UPF), a policy control function (PCF), an application function (AF), etc. The wireless network node 20 may include a processor 200 such as a microprocessor or ASIC, a storage unit 210 and a communication unit 220. The storage unit 210 may be any data storage device that stores a program code 212, which is accessed and executed by the processor 200. Examples of the storage unit 212 include but are not limited to a SIM, ROM, flash memory, RAM, hard-disk, and optical data storage device. The communication unit 220 may be a transceiver and is used to transmit and receive signals (e.g., messages or packets) according to processing results of the processor 200. In an example, the communication unit 220 transmits and receives the signals via at least one antenna 222 shown in FIG. 2.

In an embodiment, the storage unit 210 and the program code 212 may be omitted. The processor 200 may include a storage unit with stored program code.

The processor 200 may implement any steps described in exemplified embodiments on the wireless network node 20, e.g., via executing the program code 212.

The communication unit 220 may be a transceiver. The communication unit 220 may as an alternative or in addition be combining a transmitting unit and a receiving unit configured to transmit and to receive, respectively, signals to and from a wireless terminal (e.g., a user equipment or another wireless network node).

In the present disclosure, an ISAC signal comprises a communication signal/part and a sensing signal/part.

Unlike the communication signal, a radar signal (e.g., sensing signal in ISAC signal) requires large aperture in time, frequency and spatial domains. For example, the dwelling time, which is a time domain aperture, decides the sensing Doppler resolution; the bandwidth, which is the frequency domain aperture, decides the sensing range resolution; and the array size, which is the spatial domain aperture, decides the sensing angle resolution.

Thus, the present disclosure proposes a novel sensing signal forming a large radar aperture with only a small portion of spectrum resources.

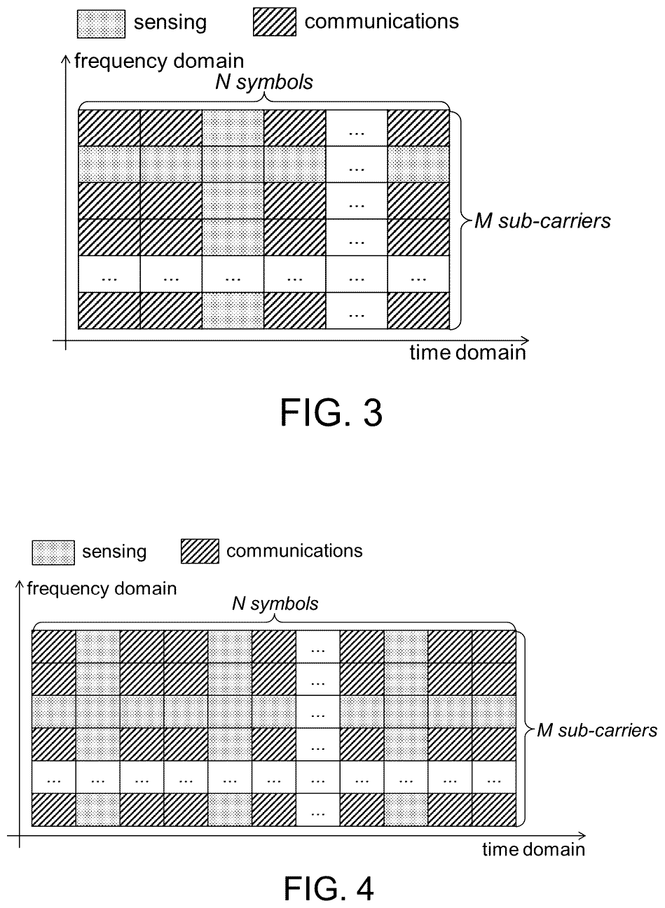

In an embodiment, an ISAC signal in the time-frequency domain is shown in FIG. 3.

As shown in FIG. 3, there are in total M sub-carriers in the frequency domain and N symbols in the time domain, which also represents MN (i.e., M×N) resource elements (REs). Among all MN REs, the sensing signal uses the m-th sub-carrier of all symbols and all sub-carriers of the n-th symbol, where 0≤m<M, and 0≤n<N.

In this embodiment, the sensing signal uses M+N−1 REs, and the remaining REs are used for communications signal. The sensing part in the ISAC signal includes a wideband signal in the n-th symbol and a single-tone signal in the other symbols. The wideband sensing signal can be FMCW, pulse signal, or low-correlation sequences. The phases of a single-tone signal in different symbols can be continuous or discontinuous. The communications part in the ISAC signal transmits information bits with a nearly full bandwidth in all symbols except the n-th symbol.

In this embodiment, for the sensing function, one node transmits the ISAC signal, and the same or another node receives the sensing part to extract information from the wireless channel. For the communications function, one node transmits the ISAC signal, and another node receives the communications part to extract information in the signal itself. Further, since the communications function also requires obtaining the channel information for demodulation, the sensing signal can also be used as the reference signal in communications.

In an embodiment, another ISAC signal in the time-frequency domain is shown in FIG. 4.

As shown in FIG. 4, there are in total M sub-carriers in the frequency domain and N symbols in the time domain, which also represents MN resource elements (REs). Among all MN REs, the sensing signal uses the m-th sub-carrier of all symbols and all sub-carriers of the n₁-th, n₂-th and n₃-th symbol, where 0≤m<M, and 0≤n₁<n₂<n₃<N.

In this embodiment, the sensing signal uses 3 M+N−3 REs, and the remaining REs are used for communications signal. The sensing part in the ISAC signal includes a wideband signal in the n₁-th, n₂-th and n₃-th symbol and a single-tone signal in the other symbols. The wideband sensing signal can be FMCW, pulse signal, or low-correlation sequences. The phases of a single-tone signal in different symbols can be continuous or discontinuous. The communications part in the ISAC signal transmits information bits with a nearly full bandwidth in all symbols except the n₁-th, n₂-th and n₃-th symbol.

In this embodiment, for the sensing function, one node transmits the ISAC signal, and the same or another node receives the sensing part to extract information from the wireless channel. For the communications function, one node transmits the ISAC signal, and another node receives the communications part to extract information in the signal itself. Further, since the communications function also requires obtaining the channel information for demodulation, the sensing signal can also be used as the reference signal in communications.

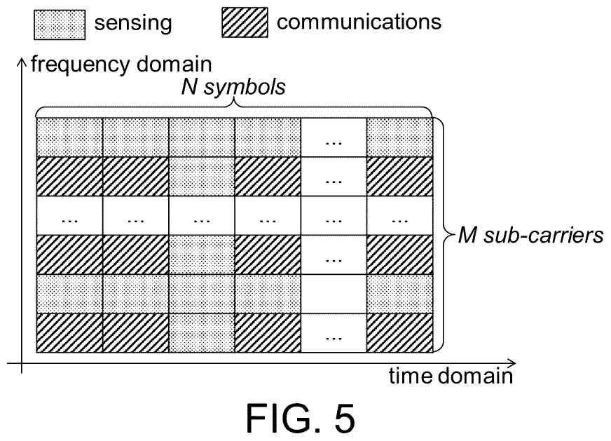

In an embodiment, another ISAC signal in the time-frequency domain is shown in FIG. 5.

As shown in FIG. 5, there are in total M sub-carriers in the frequency domain and N symbols in the time domain, which also represents MN resource elements (REs). Among all MN REs, the sensing signal uses the m₁-th and m₂-th sub-carrier of all symbols and all sub-carriers of the n-th symbol, where 0≤m₁<m₂<M, and 0≤n<N.

In this embodiment, the sensing signal uses M+2N−2 REs, and the remaining REs are used for communications signal. The sensing part in the ISAC signal includes a wideband signal in the n-th symbol and two single-tone signals in the other symbols. The wideband sensing signal can be FMCW, pulse signal, or low-correlation sequences. The phases of a single-tone signal in different symbols can be continuous or discontinuous. The communications part in the ISAC signal transmits information bits with a nearly full bandwidth in all symbols except the n-th symbol.

In this embodiment, for the sensing function, one node transmits the ISAC signal, and the same or another node receives the sensing part to extract information from the wireless channel. For the communications function, one node transmits the ISAC signal, and another node receives the communications part to extract information in the signal itself. Thus, since the communications function also requires obtaining the channel information for demodulation, the sensing signal can also be used as the reference signal in communications.

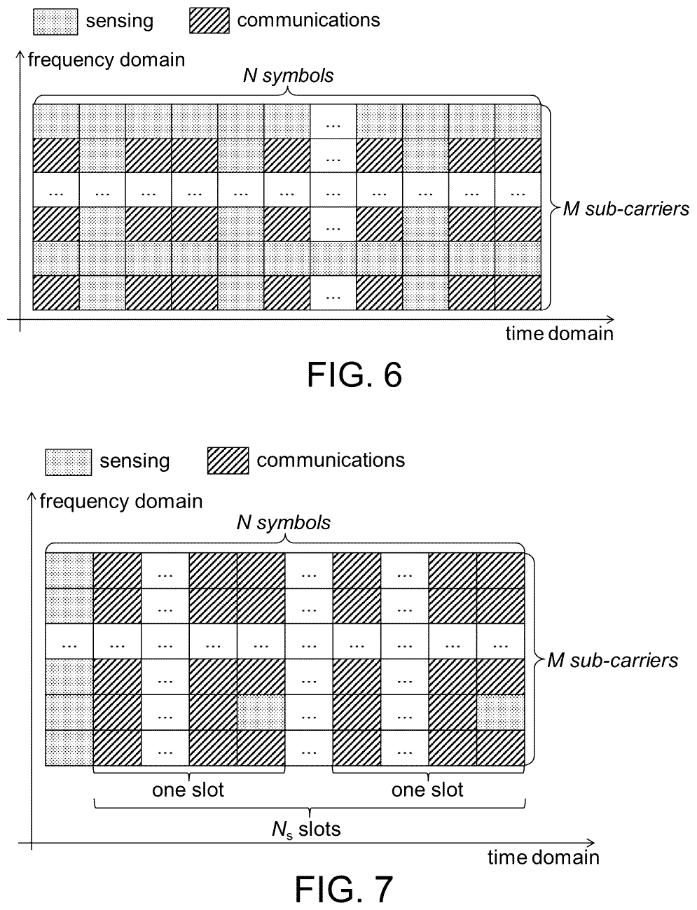

In an embodiment, another ISAC signal in the time-frequency domain is shown in FIG. 6.

As shown in FIG. 6, there are in total M sub-carriers in the frequency domain and N symbols in the time domain, which also represents MN resource elements (REs). Among all MN REs, the sensing signal uses the m₁-th and m₂-th sub-carrier of all symbols and all sub-carriers of the n₁-th, n₂-th and n₃-th symbol, where 0≤m₁<m₂<M, and 0≤n₁<n₂<n₃<N.

In this embodiment, the sensing signal uses 3 M+2N−6 REs, and the remaining REs are used for communications signal. The sensing part in the ISAC signal includes a wideband signal in the n₁-th, n₂-th and n₃-th symbol and two single-tone signals in the other symbols. The wideband sensing signal can be FMCW, pulse signal, or low-correlation sequences. The phases of a single-tone signal in different symbols can be continuous or discontinuous. The communications part in the ISAC signal transmits information bits with a nearly full bandwidth in all symbols except the n₁-th, n₂-th and n₃-th symbol.

In this embodiment, for the sensing function, one node transmits the ISAC signal, and the same or another node receives the sensing part to extract information from the wireless channel. For the communications function, one node transmits the ISAC signal, and another node receives the communications part to extract information in the signal itself. Thus, since the communications function also requires obtaining the channel information for demodulation, the sensing signal can also be used as the reference signal in communications.

In an embodiment, another ISAC signal in the time-frequency domain is shown in FIG. 7.

As shown in FIG. 7, there are in total M sub-carriers in the frequency domain and N symbols in the time domain, which also represents MN resource elements (REs). Among all MN REs, the sensing signal uses the m-th sub-carrier of the last symbols of all slots and all sub-carriers of the n-th symbol, where 0≤m<M, and 0≤n<N.

In this embodiment, the sensing signal uses M+Nₛ REs, and the remaining REs are used for communications signal. The sensing part in the ISAC signal includes a wideband signal in the n-th symbol and a single-tone signal in the other symbols. The wideband sensing signal can be FMCW, pulse signal, or low-correlation sequences. The phases of a single-tone signal in different symbols can be continuous or discontinuous. The communications part in the ISAC signal transmits information bits with a nearly full bandwidth in all symbols except the n-th symbol.

In this embodiment, for the sensing function, one node transmits the ISAC signal, and the same or another node receives the sensing part to extract information from the wireless channel. For the communications function, one node transmits the ISAC signal, and another node receives the communications part to extract information in the signal itself. Thus, since the communications function also requires obtaining the channel information for demodulation, the sensing signal can also be used as the reference signal in communications.

In an embodiment, another ISAC signal in the time-frequency domain is shown in FIG. 8.

As shown in FIG. 8, there are in total M sub-carriers in the frequency domain and N symbols in the time domain, which also represents MN resource elements (REs). Among all MN REs, the sensing signal uses the m-th sub-carrier of Nᵣ symbols with non-periodic time positions and all sub-carriers of the n-th symbol, where 0≤m<M, and 0≤n<N.

In this embodiment, the sensing signal uses M+Nᵣ REs, and the remaining REs are used for communications signal. The sensing part in the ISAC signal includes a wideband signal in the n-th symbol and a single-tone signal in the other symbols. The wideband sensing signal can be FMCW, pulse signal, or low-correlation sequences. The phases of a single-tone signal in different symbols can be continuous or discontinuous. The communications part in the ISAC signal transmits information bits with a nearly full bandwidth in all symbols except the n-th symbol.

In this embodiment, for the sensing function, one node transmits the ISAC signal, and the same or another node receives the sensing part to extract information from the wireless channel. For the communications function, one node transmits the ISAC signal, and another node receives the communications part to extract information in the signal itself. Thus, since the communications function also requires obtaining the channel information for demodulation, the sensing signal can also be used as the reference signal in communications.

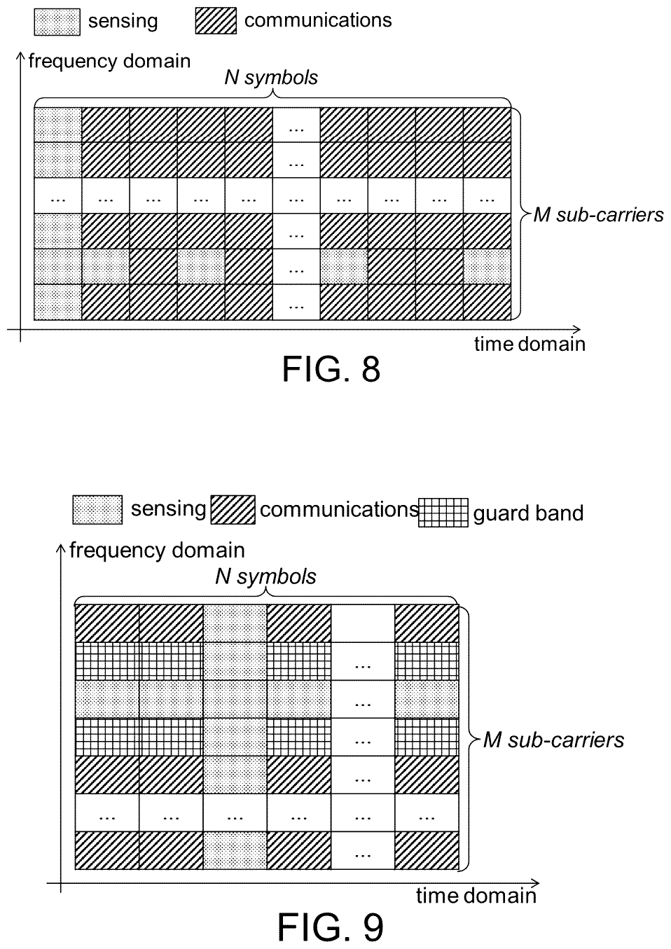

In an embodiment, another ISAC signal in the time-frequency domain is shown in FIG. 9.

As shown in FIG. 9, there are in total M sub-carriers in the frequency domain and N symbols in the time domain, which also represents MN resource elements (REs). Among all MN REs, the sensing signal uses the m-th sub-carrier of all symbols and all sub-carriers of the n-th symbol, where 0<m<M, and 0≤n<N.

In this embodiment, there are guard bands between sensing signal and communications signal to avoid interference, and the guard band takes up one sub-carrier at both sides of the sensing signal in the frequency domain. The sensing signal uses M+N−1 REs, and the remaining REs except guard bands are used for communications signal. The sensing part in the ISAC signal includes a wideband signal in the n-th symbol and a single-tone signal in the other symbols. The wideband sensing signal can be FMCW, pulse signal, or low-correlation sequences. The phases of a single-tone signal in different symbols can be continuous or discontinuous. The communications part in the ISAC signal transmits information bits with a nearly full bandwidth in all symbols except the n-th symbol.

In this embodiment, for the sensing function, one node transmits the ISAC signal, and the same or another node receives the sensing part to extract information from the wireless channel. For the communications function, one node transmits the ISAC signal, and another node receives the communications part to extract information in the signal itself. Thus, since the communications function also requires obtaining the channel information for demodulation, the sensing signal can also be used as the reference signal in communications.

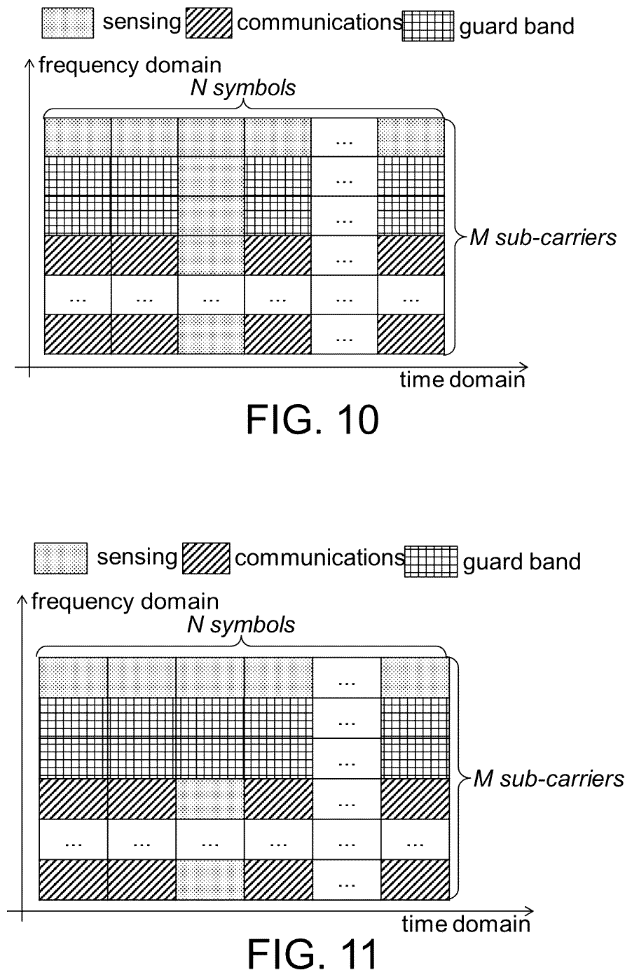

In an embodiment, another ISAC signal in the time-frequency domain is shown in FIG. 10.

As shown in FIG. 10, there are in total M sub-carriers in the frequency domain and N symbols in the time domain, which also represents MN resource elements (REs). Among all MN REs, the sensing signal uses the sub-carrier with index 0 of all symbols and all sub-carriers of the n-th symbol, where 0≤n<N.

In this embodiment, there is a guard band between sensing signal and communications signal to avoid interference, and the guard band takes up two sub-carriers at one side of the sensing signal in the frequency domain. The guard band at another side already exists in the communications system to avoid the interference between different bands.

The sensing signal uses M+N−1 REs, and the remaining REs except the guard band are used for communications signal. The sensing part in the ISAC signal includes a wideband signal in the n-th symbol and a single-tone signal in the other symbols. The wideband sensing signal can be FMCW, pulse signal, or low-correlation sequences. The phases of a single-tone signal in different symbols can be continuous or discontinuous. The communications part in the ISAC signal transmits information bits with a nearly full bandwidth in all symbols except the n-th symbol.

In this embodiment, for the sensing function, one node transmits the ISAC signal, and the same or another node receives the sensing part to extract information from the wireless channel. For the communications function, one node transmits the ISAC signal, and another node receives the communications part to extract information in the signal itself. Thus, since the communications function also requires obtaining the channel information for demodulation, the sensing signal can also be used as the reference signal in communications.

In an embodiment, another ISAC signal in the time-frequency domain is shown in FIG. 11.

As shown in FIG. 11, there are in total M sub-carriers in the frequency domain and N symbols in the time domain, which also represents MN resource elements (REs). Among all MN REs, the sensing signal uses the sub-carrier with index 0 of all symbols and all sub-carriers of the n-th symbol, where 0≤n<N.

In this embodiment, there is a guard band between sensing signal and communications signal to avoid interference, and the guard band takes up two sub-carriers at one side of the sensing signal in the frequency domain. The guard band at another side already exists in the communications system to avoid the interference between different bands.

In this embodiment, different from the embodiment described above, the guard band also exists in the n-th symbol. The sensing signal uses M+N−3 REs, and the remaining REs except the guard band are used for communications signal. The sensing part in the ISAC signal includes a wideband signal in the n-th symbol and a single-tone signal in the other symbols. The wideband sensing signal can be FMCW, pulse signal, or low-correlation sequences. The phases of a single-tone signal in different symbols can be continuous or discontinuous. The communications part in the ISAC signal transmits information bits with a nearly full bandwidth in all symbols except the n-th symbol.

In this embodiment, for the sensing function, one node transmits the ISAC signal, and the same or another node receives the sensing part to extract information from the wireless channel. For the communications function, one node transmits the ISAC signal, and another node receives the communications part to extract information in the signal itself. Thus, since the communications function also requires obtaining the channel information for demodulation, the sensing signal can also be used as the reference signal in communications.

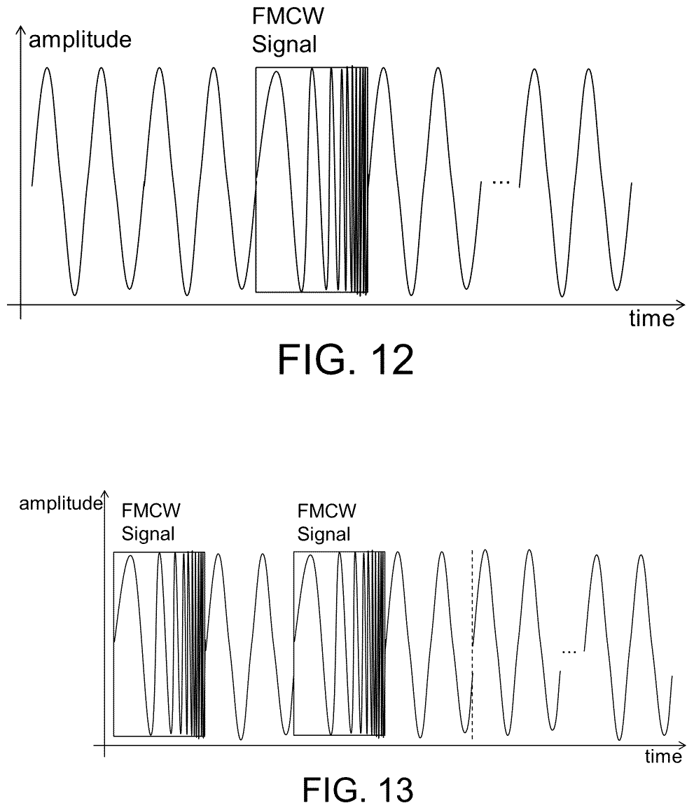

In an embodiment, the real part of a sensing signal in an ISAC signal in the time domain is shown in FIG. 12.

As shown in FIG. 12, the sensing signal is a combination of the single-tone signal and the FMCW signal. The single-tone signal and FMCW signal can be in the form of complex number or real number.

When they are in the form of a complex number, FIG. 12 is the real part, and the imaginary part can be easily obtained as the complex single-tone signal and a complex FMCW has a constant modulus.

When they are in the form of a real number, FIG. 12 is the real part, and there is no imaginary part. The combination ensures the sensing signal has both large time-domain aperture and large frequency-domain aperture to ensure the performance.

In this embodiment, the single-tone signal and the FMCW signal are multiplexed by the time division method. There is one FMCW signal, and the phase of single-tone signal is continuous.

In an embodiment, the real part of a sensing signal in another ISAC signal in the time domain is shown in FIG. 13.

As shown in FIG. 13, the sensing signal is a combination of the single-tone signal and the FMCW signal. The single-tone signal and FMCW signal can be in the form of a complex number or a real number.

When they are in the form of a complex number, FIG. 13 is the real part, and the imaginary part can be easily obtained as a complex single-tone signal and a complex FMCW has a constant modulus.

When they are in the form of a real number, FIG. 13 is the real part, and there is no imaginary part. The combination ensures the sensing signal has both large time-domain aperture and large frequency-domain aperture to ensure the performance.

In this embodiment, the single-tone signal and the FMCW signal are multiplexed by the time division method. There are two FMCW signal, and the phase of single-tone signal is discontinuous.

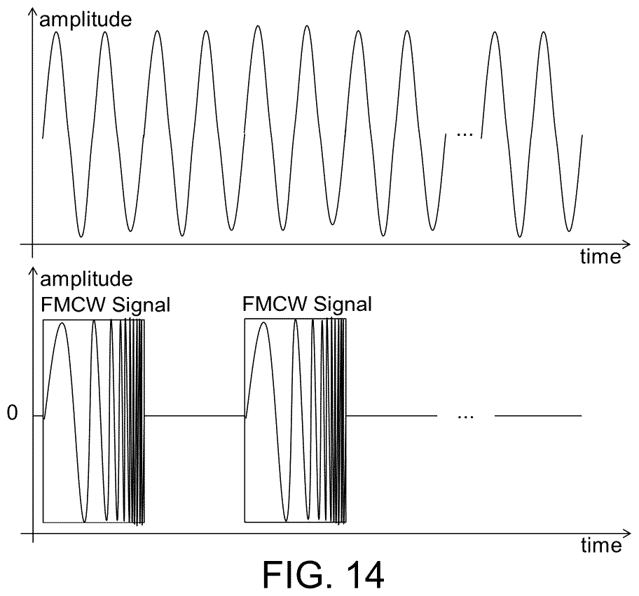

In an embodiment, the real part of sensing signal in another ISAC signal in the time domain is shown in FIG. 14.

As shown in FIG. 14, the sensing signal is a combination of the single-tone signal and the FMCW signal. The single-tone signal and FMCW signal can be in the form of a complex number or a real number.

When they are in the form of a complex number, FIG. 14 is the real part, and the imaginary part can be easily obtained as a complex single-tone signal and a complex FMCW has a constant modulus.

When they are in the form of real number, FIG. 14 is the real part, and there is no imaginary part. The combination ensures the sensing signal has both large time-domain aperture and large frequency-domain aperture to ensure the performance.

In this embodiment, the single-tone signal and the FMCW signal are superimposed. There are two FMCW signals, and the phase of single-tone signal is continuous.

In an embodiment, the sensing part in an ISAC signal in the time-frequency-spatial domain is shown in FIG. 15.

As shown in FIG. 15, this embodiment further extends all of the previously described embodiments into the time-frequency-spatial domain. The time and frequency domain resources are measured by the number of symbols and sub-carriers, respectively. The spatial domain resources are measured by the number of antenna or the number of beams.

The beam can be seen as a virtual antenna port, and the number of antenna is used for simplicity. In this embodiment, it is assumed that the ISAC symbol uses N symbols, M sub-carriers and L antennas.

As shown in FIG. 15, the sensing signal uses M sub-carrier and one antenna in the n₁-th symbol, one sub-carrier and L antennas in the n₂-th symbol, and one sub-carrier and one antenna in the other symbols, where 0≤n₁≤n₂<N.

In the time-frequency domain, the resource allocation is the same as that in the first described embodiment. However, this can easily be extended to any of the above described embodiments.

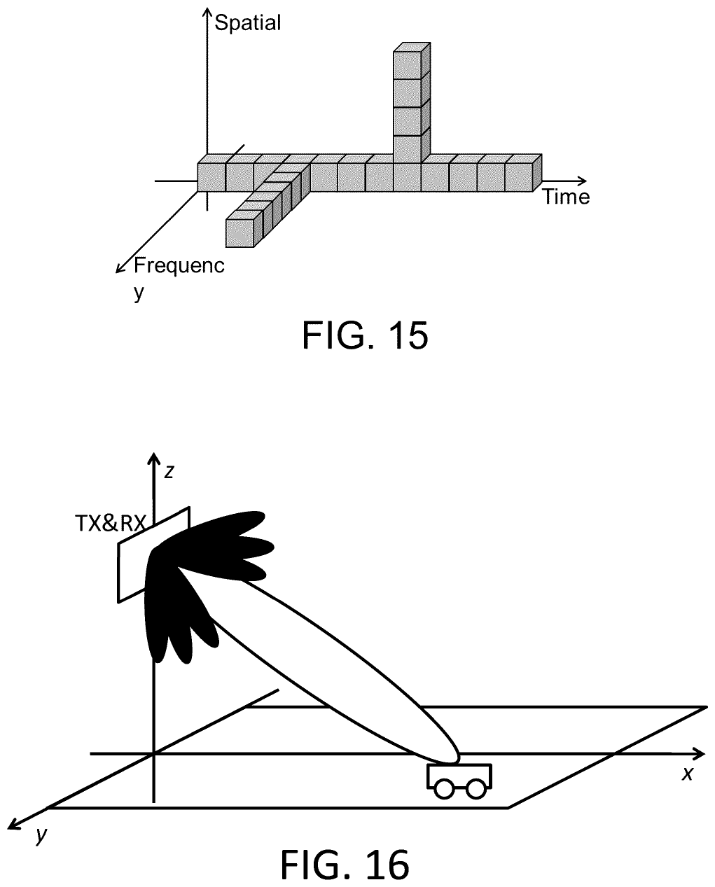

In an embodiment, the monostatic sensing mode is shown in FIG. 16.

As shown in FIG. 16, in the ISAC signal, the communications signal is transmitted from one node to another node, while the sensing signal can have different transmitting modes.

In this embodiment of monostatic sensing, one node sends the ISAC signal and receives the echo of the sensing signal in the ISAC signal. Mono-static is a common radar mode.

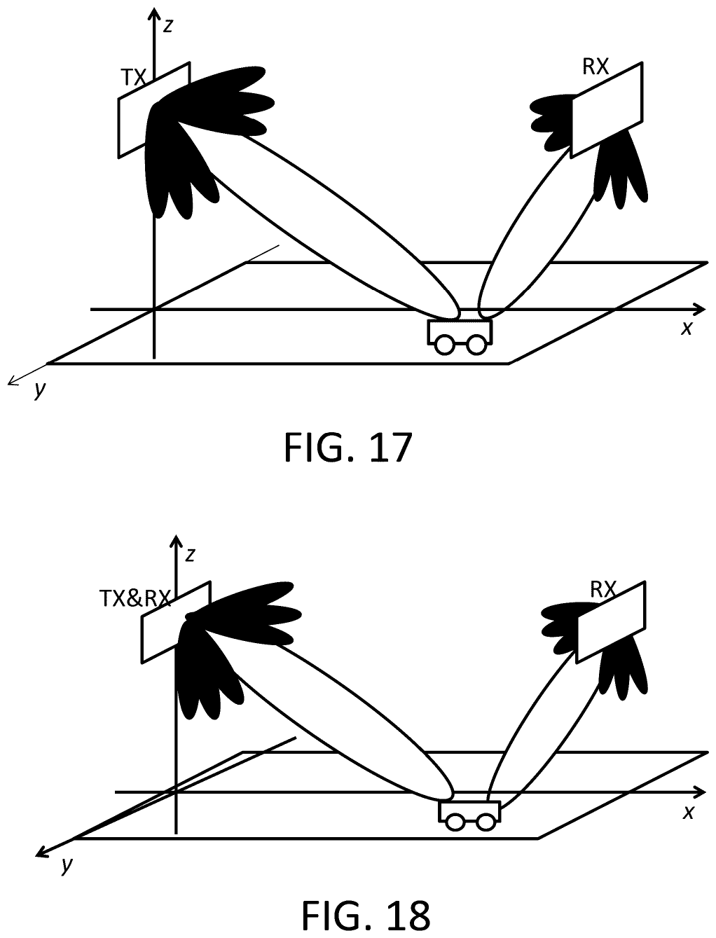

In an embodiment, the bistatic and multi-static sensing mode is shown in FIG. 17.

As shown in FIG. 17, in the ISAC signal, the communications signal is transmitted from one node to another node, while the sensing signal can have different transmitting modes.

In this embodiment of bistatic and multi-static sensing, one node sends the ISAC signal, and another node receives the echo of the sensing signal in the ISAC signal. This sensing mode is named bistatic. If there are more than one node receiving the echo of the sensing signal in the ISAC signal it is named multi-static. The present embodiment only shows the bistatic mode, because a multi-static mode can be seen as multiple pairs of bistatic sensing.

In an embodiment, the monostatic plus bistatic sensing mode is shown in FIG. 18.

As shown in FIG. 18, in the ISAC signal, the communications signal is transmitted from one node to another node, while the sensing signal can have different transmitting modes.

In this embodiment of monostatic plus bistatic sensing, one node sends the ISAC signal, and this node and another node receive the echo of the sensing signal in the ISAC signal.

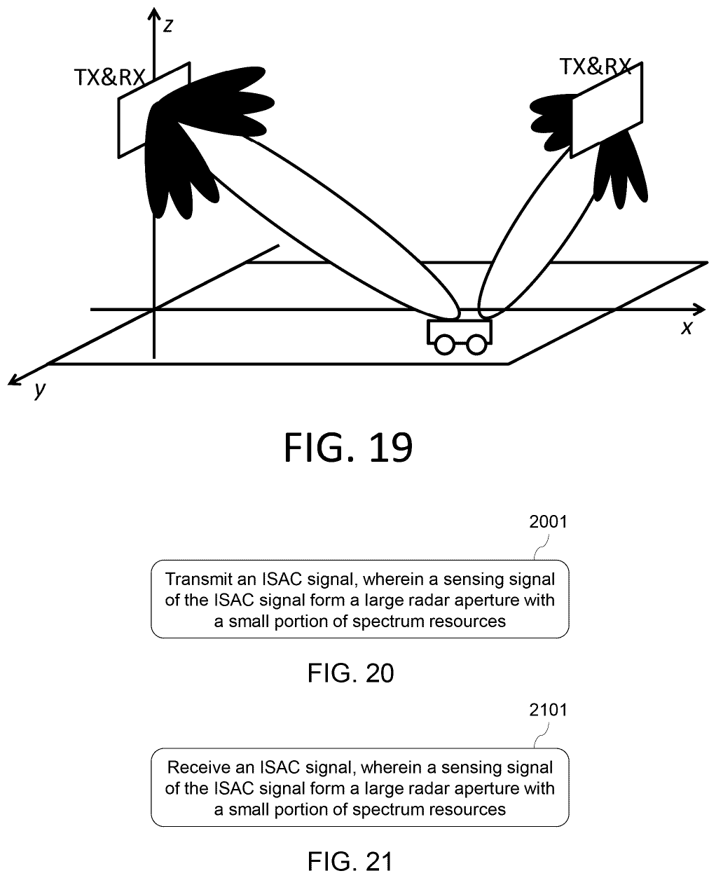

In an embodiment, the multi-cell monostatic sensing mode is shown in FIG. 19.

As shown in FIG. 19, in the ISAC signal, the communications signal is transmitted from one node to another node, while the sensing signal can have different transmitting modes.

In this embodiment of the multi-cell monostatic sensing, one node sends the first ISAC signal and receives the echo of the first sensing signal in the ISAC signal, and another node sends the second ISAC signal and receives the echo of the sensing signal in the second ISAC signal. To avoid interference, the sensing signal of two ISAC signals can use different time-frequency positions.

In an embodiment of the present disclosure, one communication and sensing node sends an ISAC signal and the ISAC signal may be received by the same communication and sensing node and/or another communication and sensing node. Based on the received ISAC signal (e.g., communication signal and/or sensing signal of the ISAC signal), the same communication and sensing node and/or another communication and sensing node determines communication information (e.g., data) and/or sensing information (e.g., position) of an object/target. For example, the communication and sensing node may extract the sensing information from wireless channel(s)/paths of the sensing signal.

In an embodiment, the sensing signal in the ISAC signal is a combination of at least one single-tone signal and a wideband signal. In the present disclosure, the wideband signal may be defined as a signal with a bandwidth larger than 1 MHz. In an embodiment, the wideband signal is defined as a signal with a bandwidth significantly exceeds the coherence bandwidth of the channel or a signal with a bandwidth larger than 1% of the carrier frequency.

In an embodiment, the number of at least one single-tone signal may be less than 10.

In an embodiment, the number of single-tone signals is 1.

In an embodiment, a total time duration of the wideband signal is less than that of the single-tone signal(s). Note that the time duration of a signal is time duration/length from the start of the signal to the end of the signal.

In an embodiment, the number of sub-carriers used by the single-tone signal(s) is not smaller than 10% of the total number of sub-carriers of the ISAC signal.

In an embodiment, the wideband signal may be an FMCW signal, pulse signal or low-correlation sequence signal.

In an embodiment, the wideband signal uses all sub-carriers of the ISAC signal.

In an embodiment, the wideband signal uses more than 90% sub-carriers of the ISAC signal.

In an embodiment, a (total) time duration of the wideband signal is smaller than the 20% or 10% of a (total) time duration of the ISAC signal.

In an embodiment, a time spacing between the first and last time-domain position of the single-tone signal(s) is larger than 90% of the total time duration of the ISAC signal. In the present disclosure, the time-domain position of a signal may be a position of a symbol, a slot or a frame of the signal.

In an embodiment, the single-tone signal(s) has an arbitrary duty cycle. That is the duty cycle of the single tone signal(s) is within 0 to 100%.

In an embodiment, the time-domain positions of the single-tone signal(s) in the ISAC signal is periodic or non-periodic.

In an embodiment, the phase of the sing-tone signal(s) is continuous or discontinuous.

In an embodiment, guard band(s) is inserted between the sensing signal(s) and the communications signal.

In an embodiment, the sensing signal is used as the reference signal of the communications signal.

Note that the ISAC signal may be used in the sensing modes including monostatic, bistatic, and multi-static.

In an embodiment, different cells simultaneously sense the same target using the same or different sensing modes including monostatic, bistatic, and multi-static.

FIG. 20 shows a flowchart of a method according to an embodiment of the present disclosure. The method may be used in a wireless sensing and communication node or wireless communication and sensing node and comprises the following step:

Step 2001: Transmit an ISAC signal, wherein a sensing signal of the ISAC signal form a large radar aperture with a small portion of spectrum resources.

In this embodiment, the ISAC signal comprises a wideband signal and at least one single-tone signal. In order to form the large radar aperture with a small portion of spectrum resources, the number of the at least one single-tone signal may be less than 10 and/or a bandwidth of the wideband signal may be greater than 1 MHz.

In an embodiment, a (total) time duration of the wideband signal is less than a (total) time duration of the at least one single-tone signal. The time duration of the wideband/single-tone signal is a time duration/length from the start (e.g., the first symbol/RE) of the wideband/single-tone signal to the end (e.g. the last symbol/RE) of the wideband/single-tone signal.

In an embodiment, the number of sub-carriers used by the at least one single-tone signal is smaller than 10% of the total number of sub-carriers of the ISAC signal.

In an embodiment, the number of at least one single-tone signal is 1.

In an embodiment, the wideband signal is one of an FMCW signal, a pulse signal or a low-correlation sequence signal.

In an embodiment, the bandwidth of the wideband signal covers all sub-carriers of the ISAC signal.

In an embodiment, the bandwidth of the wideband signal covers more than 90% of sub-carriers of the ISAC signal.

In an embodiment, a time duration of the wideband signal is less than 10% of a time duration of the ISAC signal. The time duration of the single-tone/ISAC signal is a time duration/length from the start (e.g., the first symbol/RE) of the single-tone/ISAC signal to the end (e.g. the last symbol/RE) of the single-tone/ISAC signal.

In an embodiment, a time spacing between the first time-domain position and the last time-domain position of the single-tone signal is greater than 90% of a time duration of the ISAC signal. The time duration of the (single-tone) signal is a time duration/length from the start (e.g., the first symbol/RE) of the (single-tone) signal to the end (e.g. the last symbol/RE) of the (single-tone) signal.

In an embodiment, a duty cycle of the single-tone signal is within 0% to 100%.

In an embodiment, time-domain positions (e.g., the positions of symbols, slots or frames) of the single-tone signal are periodic or non-periodic.

In an embodiment, a phase of the single-tone signal is continuous or discontinuous.

In an embodiment, the ISAC signal further comprises at least one guard band between the single-tone signal and a communication signal of the ISAC signal.

In an embodiment, the single-tone signal is on a subcarrier with the highest frequency or the lowest frequency in the ISAC signal.

In an embodiment, each guard band covers at least one subcarrier of the ISAC signal.

In an embodiment, the at least one single-tone signal is a reference signal of the communication signal in the ISAC signal.

In an embodiment, the wireless sensing and communication node uses a plurality of antennas and/or a plurality of beams to transmit at least one signal component (e.g., subcarrier or symbol) (see FIG. 15).

In an embodiment, the wireless sensing and communication node receives (an echo signal corresponding to) the sensing signal transmitted by itself and determines sensing information (of an object/target) based on the received sensing signal (e.g., the echo signal).

FIG. 21 shows a flowchart of a method according to an embodiment of the present disclosure. The method may be used in a wireless communication and sensing node (e.g., BS or UE) and comprises the following step:

Step 2101: Receive an ISAC signal, wherein a sensing signal of the ISAC signal form a large radar aperture with a small portion of spectrum resources.

In this embodiment, the wireless communication and sensing node receives an ISAC signal comprising a sensing signal which forms a large radar aperture with a small portion of spectrum resources. For example, the ISAC signal may comprise a wideband signal and at least one single-tone signal, wherein the number of the at least one single-tone signal may be less than 10 and/or a bandwidth of the wideband signal may be greater than 1 MHz. Note that, according to an embodiment of the present disclosure, receiving the ISAC signal may be equal to receiving the communication signal and/or the sensing signal (or an echo signal corresponding to the sensing signal) of the ISAC signal.

In an embodiment, the wireless communication and sensing node determines communication information and/or sensing information (of an object/target) based on the ISAC signal.

In an embodiment, a (total) time duration of the wideband signal is less than a (total) time duration of the at least one single-tone signal. The time duration of the wideband/single-tone signal is a time duration/length from the start (e.g., the first symbol/RE) of the wideband/single-tone signal to the end (e.g. the last symbol/RE) of the wideband/single-tone signal.

In an embodiment, the number of sub-carriers used by the at least one single-tone signal is smaller than 10% of the total number of sub-carriers of the ISAC signal.

In an embodiment, the number of at least one single-tone signal is 1.

In an embodiment, the wideband signal is one of an FMCW signal, a pulse signal or a low-correlation sequence signal.

In an embodiment, the bandwidth of the wideband signal covers all sub-carriers of the ISAC signal.

In an embodiment, the bandwidth of the wideband signal covers more than 90% of sub-carriers of the ISAC signal.

In an embodiment, a time duration of the wideband signal is less than 10% of a time duration of the ISAC signal. The time duration of the single-tone/ISAC signal is a time duration/length from the start (e.g., the first symbol/RE) of the single-tone/ISAC signal to the end (e.g. the last symbol/RE) of the single-tone/ISAC signal.

In an embodiment, a time spacing between the first time-domain position and the last time-domain position of the single-tone signal is greater than 90% of a time duration of the ISAC signal. The time duration of the (single-tone) signal is a time duration/length from the start (e.g., the first symbol/RE) of the (single-tone) signal to the end (e.g. the last symbol/RE) of the (single-tone) signal.

In an embodiment, a duty cycle of the single-tone signal is within 0% to 100%.

In an embodiment, time-domain positions (e.g., the time-domain positions of symbols, slots or frames) of the single-tone signal are periodic or non-periodic.

In an embodiment, a phase of the single-tone signal is continuous or discontinuous.

In an embodiment, the ISAC signal further comprises at least one guard band between the single-tone signal and a communication signal of the ISAC signal.

In an embodiment, the single-tone signal is on a subcarrier with the highest frequency or the lowest frequency in the ISAC signal.

In an embodiment, each guard band covers at least one subcarrier of the ISAC signal.

In an embodiment, the at least one single-tone signal is a reference signal of the communication signal in the ISAC signal.

In an embodiment, the wireless sensing and communication node receives at least one signal component (e.g., subcarrier or symbol) via a plurality of antennas and/or a plurality of beams (see FIG. 15).

In an embodiment, the ISAC signal is received from another wireless communication and sensing node.

In an embodiment, the ISAC signal is sent by the wireless communication and sensing node itself.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according to embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication and sensing method for use in a wireless communication and sensing node, the wireless communication and sensing method comprising:
transmitting an integrated sensing and communication (ISAC) signal,
wherein a sensing signal in the ISAC signal comprises a wideband signal and at least one single-tone signal,
wherein the number of the at least one single-tone signal is less than 10, and
wherein a bandwidth of the wideband signal is greater than 1 MHz.

2. The wireless communication and sensing method of claim 1, wherein the wideband signal is one of a Frequency-Modulated Continuous Wave (FMCW) signal, a pulse signal or a low-correlation sequence signal.

3. The wireless communication and sensing method of claim 1, wherein the bandwidth of the wideband signal covers more than 90% of sub-carriers of the ISAC signal.

4. The wireless communication and sensing method of claim 1, wherein a time duration of the wideband signal is less than 10% of a time duration of the ISAC signal.

5. The wireless communication and sensing method of claim 1, wherein a time spacing between the first time-domain position and the last time-domain position of the single-tone signal is greater than 90% of a time duration of the ISAC signal, and
wherein a duty cycle of the single-tone signal is within 0% to 100%, time-domain positions of the single-tone signal are periodic or non-periodic, and a phase of the single-tone signal is continuous or discontinuous.

6. The wireless communication and sensing method of claim 1, wherein the ISAC signal further comprises at least one guard band between the single-tone signal and a communication signal of the ISAC signal.

7. The wireless communication and sensing method of claim 6, wherein:
the single-tone signal is on a subcarrier with the highest frequency or the lowest frequency in the ISAC signal, and
each guard band covers at least one subcarrier of the ISAC signal, and
the at least one single-tone signal is a reference signal of a communication signal in the ISAC signal.

8. The wireless communication and sensing method of claim 1, wherein transmitting the ISAC signal comprises:
transmitting at least one signal component of the sensing signal via a plurality of antennas and/or a plurality of beams, and further comprising:
receiving an echo signal corresponding to the sensing signal of the ISAC signal, and
determining sensing information based on the echo signal.

9. The wireless communication and sensing method of claim 1, wherein a total time duration of the wideband signal is less than a total time duration of the at least one single-tone signal.

10. A wireless communication and sensing method for use in a wireless communication and sensing node, the wireless communication and sensing method comprising:
receiving an integrated sensing and communication (ISAC) signal, and
determining communication information and sensing information based on the ISAC signal,
wherein a sensing signal in the ISAC signal comprises a wideband signal and at least one single-tone signal,
wherein the number of the at least one single-tone signal is less than 10, and
wherein a bandwidth of the wideband signal is greater than 1 MHz.

11. The wireless communication and sensing method of claim 10, wherein the wideband signal is one of a Frequency-Modulated Continuous Wave (FMCW) signal, a pulse signal or a low-correlation sequence signal, the bandwidth of the wideband signal covers 90% of sub-carriers of the ISAC signal, and a time duration of the wideband signal is less than 10% of a time duration of the ISAC signal.

12. The wireless communication and sensing method of claim 10, wherein a time spacing between the first time-domain position and the last time-domain position of the single-tone signal is greater than 90% of a time duration of the ISAC signal, and
wherein a duty cycle of the single-tone signal is within 0% to 100%, and
wherein time-domain positions of the single-tone signal are periodic or non-periodic, and
wherein a phase of the single-tone signal is continuous or discontinuous.

13. The wireless communication and sensing method of claim 10, wherein the ISAC signal further comprises at least one guard band between the single-tone signal and a communication signal of the ISAC signal.

14. The wireless communication and sensing method of claim 13, wherein:
the single-tone signal is on a subcarrier with the highest frequency or the lowest frequency in the ISAC signal, and
each guard band covers at least one subcarrier of the ISAC signal, and
the at least one single-tone signal is a reference signal of a communication signal in the ISAC signal, and
a total time duration of the wideband signal is less than a total time duration of the at least one single-tone signal.

15. The wireless communication and sensing method of claim 10, wherein at least one signal component of the sensing signal corresponds to at least one of a plurality of antennas or a plurality of beams, and
wherein the ISAC signal is sent by the wireless communication and sensing node or by another wireless communication and sensing node.

16. The wireless communication and sensing method of claim 10, wherein receiving the ISAC signal comprises:
receiving an echo signal corresponding to the sensing signal of the ISAC signal.

17. A wireless communication and sensing node, comprising:
a communication unit, configured to transmit an integrated sensing and communication, ISAC, signal,
wherein a sensing signal in the ISAC signal comprises a wideband signal and at least one single-tone signal,
wherein the number of the at least one single-tone signal is less than 10, and
wherein a bandwidth of the wideband signal is greater than 1 MHz.

18. The wireless communication and sensing node of claim 17, wherein the wideband signal is one of a Frequency-Modulated Continuous Wave (FMCW) signal, a pulse signal or a low-correlation sequence signal.

19. A wireless communication and sensing node, comprising:
a communication unit, configured to transmit an integrated sensing and communication (ISAC) signal, and
a processor, configured to determine communication information and sensing information based on the ISAC signal,
wherein a sensing signal in the ISAC signal comprises a wideband signal and at least one single-tone signal,
wherein the number of the at least one single-tone signal is less than 10, and
wherein a bandwidth of the wideband signal is greater than 1 MHz.

20. The wireless communication and sensing node of claim 19, wherein the wideband signal is one of a Frequency-Modulated Continuous Wave (FMCW) signal, a pulse signal or a low-correlation sequence signal, the bandwidth of the wideband signal covers 90% of sub-carriers of the ISAC signal, and a time duration of the wideband signal is less than 10% of a time duration of the ISAC signal.
